(19) United States
(12) Patent Application Publication
(10) Pub. No.: US 2026/0031719 A1
(43) Pub. Date: Jan. 29, 2026

(54) UNEVEN TAPPED WINDING IN ASYMMETRIC HALF-BRIDGE TOPOLOGY

(71) Applicant: Murata Manufacturing Co., Ltd., Nagaokakyo-shi (JP)

(72) Inventor: Takayuki TANGE, Milton Keynes (GB)

(21) Appl. No.: 19/278,454

(22) Filed: Jul. 23, 2025

Related U.S. Application Data
(60) Provisional application No. 63/674,434, filed on Jul. 23, 2024.

(51) Int. Cl. H02M 3/00; H02M 3/335

(52) U.S. Cl. CPC H02M 3/003; H02M 3/33571; H02M 3/33573

(57) ABSTRACT

A DC-DC converter includes input and output voltage terminals; a transformer including a primary winding, a first secondary winding, and a second secondary winding, the first and the second secondary windings having a different number of turns; a primary circuit connected between the input voltage terminals and the primary winding and including an integrated circuit (IC) including power switches, a switch-output terminal, and a feedback terminal; and a voltage divider connected between the switch-output terminal and the feedback terminal such that a duty cycle of the power switches is set by equation (1):

$$Duty Cycle = \frac{S 1 turns}{S 1 turns + S 2 turns} \qquad ( 1 )$$

where S1 turns is a number of turns in the first secondary winding and S2 turns is a number of turns in the second secondary winding; and a secondary circuit connected to the first and the second secondary windings and including a rectifier and the output voltage terminals.

### CROSS REFERENCE TO RELATED APPLICATIONS

This application claims the benefit of U.S. Patent Application No. 63/674,434 filed on Jul. 23, 2024. The entire contents of this application are hereby incorporated by reference.

### BACKGROUND OF THE INVENTION

### 1. Field of the Invention

The present invention relates to converters. More specifically, the present invention relates to converters with uneven tapped windings.

### 2. Description of the Related Art

FIG. 1 shows a known isolated DC-DC converter 200 that includes a non-isolated buck converter as a primary side 202 and that includes a secondary side 252 that is isolated from and controlled by the primary side 202. An input voltage VIN is input into the VIN terminal of the step-down IC 204, and the VIN terminal is connected to ground via a first capacitor 206. The enable signal EN is input into the EN terminal of the step-down IC 204. The SW terminal is connected to one end of a first inductor 208. The other end of the first inductor 208 is connected to the OUT terminal of the step-down IC 204 and is connected to ground via a first resistor 210 and a second resistor 212 in series. The other end of the first inductor 208 is also connected to ground via a second capacitor 214 and is connected to an output terminal 216 that provides output voltage V_{OUT1}. The FB terminal is connected to the midpoint between the first and second resistors 210, 212, and the GND terminal is connected to ground.

The first inductor 208 is coupled to a second inductor 254 in the secondary side 252, such that the first inductor 208 and the second inductor 254 define a transformer. The first inductor 208 and second inductor 254 may typically be formed from coils. The first inductor 208 and the second inductor 254 are coupled via a magnetic core. The first inductor 208 defines the primary windings of the transformer, and the second inductor 254 defines the secondary windings of the transformer. The secondary side 252 is electrically isolated from the primary side 202 by the transformer. The secondary side 252 also includes a rectifying circuit 256, a third inductor 258, and a third capacitor 260. The rectifying circuit 256 is a two-diode, center-tapped, full-wave rectifier that includes a first diode 262, a second diode 264, and a center-tap halfway along the second inductor 254 which is connected to ground. The anode of the first diode 262 and the anode of the second diode 264 are connected to opposite ends of the second inductor 254. The cathode of the first diode 262 and the cathode of the second diode 264 are connected to one end of the third inductor 258. The third capacitor 260 is connected between the output at the other end of the third inductor 258 and ground. The voltage over the third capacitor 260 is the isolated output voltage V_{OUT2} of the isolated DC-DC converter 200. The isolated DC-DC converter 200 therefore includes two independent outputs. The first is the non-isolated stepped down output voltage V_{OUT1} of the buck converter of the primary side 202 at the output terminal 216. The second output is the output voltage V_{OUT2} of the secondary side 252 that is isolated by virtue of the transformer.

In the isolated DC-DC converter 200 of FIG. 1, if the duty cycle of the step-down IC 204 is adjusted to set the output voltage or to reduce negative current flow into the step-down IC 204, then the voltage the first diode 262 and the second diode 264 are different so that the peak current of inductor 258 is larger, which causes extra losses and a decrease in efficiency. If the rectifying circuit 256 includes a two-diode, center-tapped, full-wave rectifier that includes the first diode 262 and the second diode 264, then it is more likely that the isolated DC-DC converter 200 is operated in discontinuous current mode (DCM) during light loads, causing poor load regulation.

### SUMMARY OF THE INVENTION

To overcome the problems described above, example embodiments of the present invention provide converters with uneven tapped windings that provide improved efficiency because the peak current of the converters can be reduced and that provide improved load regulation by avoiding DCM during light loads.

According to an example embodiment of the present invention, a DC-DC converter includes input voltage terminals and output voltage terminals; a transformer including a primary winding, a first secondary winding, and a second secondary winding, the first and the second secondary windings having a different number of turns; a primary circuit connected between the input voltage terminals and the primary winding and including an integrated circuit (IC) including power switches, a switch-output terminal, and a feedback terminal; and a voltage divider connected between the switch-output terminal and the feedback terminal such that a duty cycle of the power switches is set by equation (1):

$$Duty Cycle = \frac{S 1 turns}{S 1 turns + S 2 turns} \qquad ( 1 )$$

where S1 turns is a number of turns in the first secondary winding and S2 turns is a number of turns in the second secondary winding; and a secondary circuit connected to the first and the second secondary windings and including a rectifier and the output voltage terminals.

The power switches can be arranged in a half-bridge arrangement or in a full-bridge arrangement. The voltage divider can include first and second resistors connected in series between the switch-output terminal and a ground, and the feedback terminal can be connected to a node between the first and the second resistors. The DC-DC converter can further include a third resistor connected between the feedback terminal and the node between the first and the second resistors.

The first and the second secondary windings can define a tap that is connected to one of the output voltage terminals. The rectifier can include a first diode connected to the first secondary winding and includes a second diode connected to the second secondary winding. The secondary winding can include a filter connected between the rectifier and the output terminals. The filter can include a filter capacitor connected across the output voltage terminals and includes a filter inductor connected between the rectifier and the filter capacitor. The IC can include a bootstrap terminal connected to the switch-output terminal. The DC-DC converter can further include a bootstrap capacitor and a bootstrap resistor connected in series between the bootstrap terminal and the switch-output terminal.

The DC-DC converter can further include a capacitor connected between the primary winding and one of the input voltage terminals. The DC-DC converter can further include an input capacitor connected between the input voltage terminals.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 is a circuit diagram of a known isolated DC-DC converter.

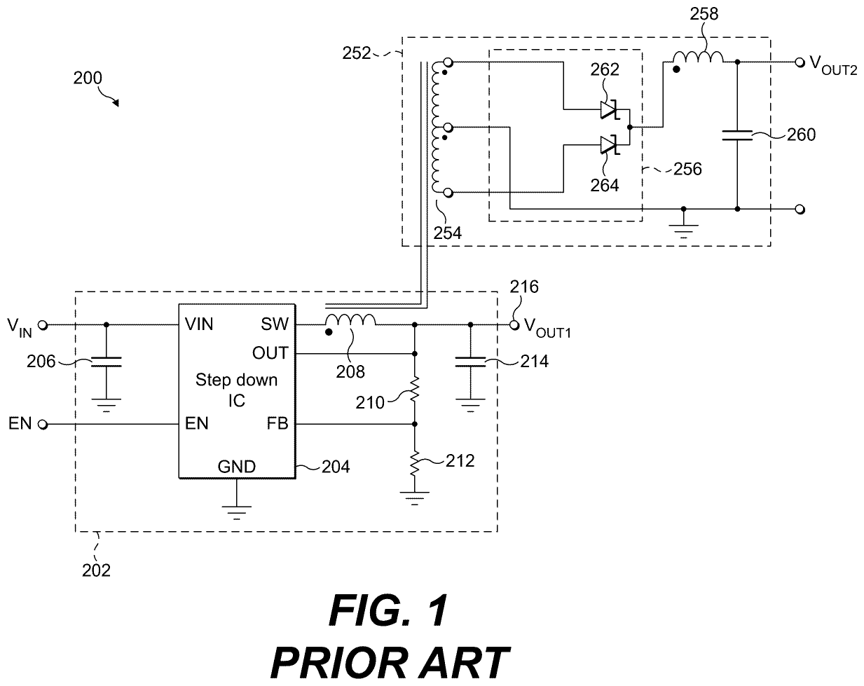

FIG. 2 is a circuit diagram of DC-DC converter with uneven tapped windings.

### DETAILED DESCRIPTION OF EXAMPLE EMBODIMENTS

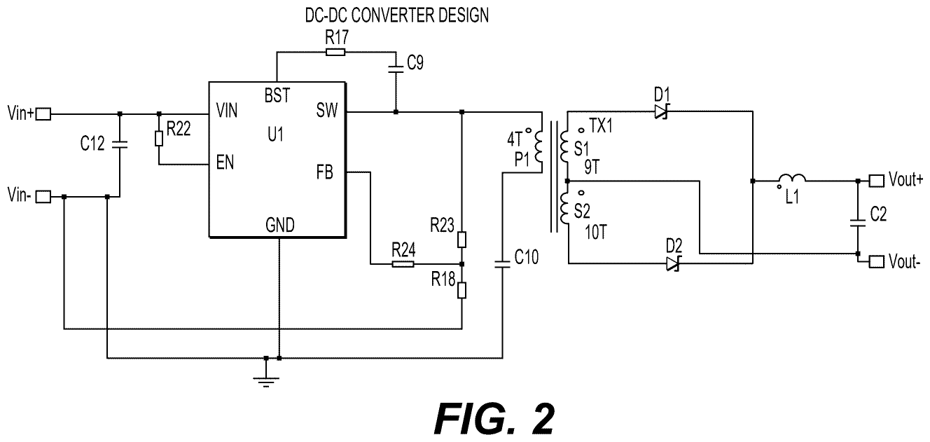

FIG. 2 shows an isolated DC-DC converter that includes a primary circuit and a secondary circuit connected by a transformer TX1. The primary circuit is connected to the primary winding P1 of the transformer TX1, and the secondary circuit is connected to the first and the second secondary windings S1, S2 of the transformer TX1. The converter includes input voltage terminals Vin+, Vin− that receive a DC-DC voltage and includes output voltage terminals Vout+, Vout− that provide a DC-DC voltage.

As shown in FIG. 2, the transformer TX1 can include a single primary winding P1 and a tapped secondary winding with first and second secondary windings S1, S2. The tap of the tapped secondary winding can be connected to the output voltage terminal Vout−. The number of turns of the first secondary winding S1 and the number of turns of the second secondary winding S2 are different. FIG. 2 shows that the primary winding P1 has four turns, the first secondary winding S1 has 9 turns, and the second secondary winding S2 has 10 turns. But the primary winding P1 and the first and second secondary windings S1, S2 can have other numbers of turns. For example, the primary winding P1 can have 5 turns, the first secondary winding S1 can have 10 turns, and the second secondary winding S2 can have 11 turns.

The primary circuit includes a switching circuit connected to the primary winding P1. The switching circuit converts the input DC voltage into positive voltages and negative voltages that are applied to the primary winding P1. The switching circuit can include an integrated circuit (IC) U1 that includes an input terminal VIN, an enable terminal EN, a ground terminal GND, a bootstrap terminal BST, a switch-output terminal SW, and a feedback terminal FB. Any suitable IC can be used as the IC U1. The IC U1 can be used with a half-bridge or full-bridge topology and can provide duty cycle control of the power switches included within the IC U1. The IC U1 can be a fully integrated, high-frequency, synchronous, rectified, step-down, switch-mode converter with internal power switches. For example, the power switches can be any suitable transistor, including, for example, metal-oxide-semiconductor field-effect transistors (MOSFETs). The power switches can be arranged in a half-bridge topology or a full-bridge topology. The IC U1 can provide about 1 A of continuous output current with load and line regulation over a wide input voltage range. The IC U1 can use synchronous mode operation for higher efficiency over the output current load range. The IC U1 can include power switches arranged in a half-bridge or full-bridge arrangement.

The primary circuit also includes an input capacitor C12 connected across the input voltage terminals Vin+, Vin−. A first terminal of the capacitor C12 can be connected to the input voltage terminal Vin+, and a second terminal of the capacitor C12 can be connected to the input voltage terminal Vin− and to ground. The input terminal VIN is connected to the input voltage terminal Vin+. One of the terminals of the input capacitor C12 is connected to the input terminal VIN and the input voltage terminal Vin+, and the other terminal of the input capacitor C12 is connected to the input voltage terminal Vin− and ground. The enable terminal EN turns on the IC U1 when a voltage is applied, turns off the IC U1 when no voltage is applied, and is connected to input capacitor C12 via resistor R22. The resistor R22 is used to provide a voltage to the enable terminal EN of the IC U1. The resistor R22 can also provide overvoltage prevention for the enable terminal EN. The ground terminal GND and the input voltage terminal Vin− are connected to ground. The switch-output terminal SW is connected to a first terminal of the primary winding P1 of the transformer TX1, and the capacitor C10 is connected to a second terminal of the primary winding P1. The capacitor C10 can be used for charging at a certain voltage. The bootstrap terminal BST is connected to the switch-output terminal SW via a resistor R17 and a capacitor C9. The capacitor C9 can be used to drive the high-side power switch, and the resistor R17 can be used to reduce switching surge when the high-side power switch is turned ON and OFF. The feedback terminal FB is connected to the switch-output terminal SW via a voltage divider. As shown in FIG. 2, the voltage divider can include resistors R23, R18 connected in series between the switch-output terminal SW and the input voltage terminal Vin− and can include a resistor R24 connected between the feedback terminal FB and a node between the resistors R23, R18. In some applications, the resistor R24 can be omitted.

The secondary circuit includes a rectifier connected to the first and the second secondary windings S1, S2 and includes a filter connected between the rectifier and the output voltage terminals Vout+, Vout−. The rectifier includes first and second diodes D1, D2. The anode of the first diode D1 can be connected to the first terminal of the first secondary winding S1, and the cathode of the first diode D1 can be connected to the filter. The second terminal of the first secondary winding S1 can be connected to the first terminal of the second secondary winding S1 to define a tapped secondary winding. The anode of the second diode D2 can be connected to the second terminal of the second secondary winding S2, and the cathode of the second diode D2 can be connected to the filter.

The filter can include an inductor L1 and a capacitor C2. The inductor L1 is connected between the rectifier and the output voltage terminal Vout+. The capacitor C2 is connected across the output voltage terminals Vout+, Vout−. A first terminal of the inductor L1 is connected to the cathodes of the first and the second diodes D1, D2. A second terminal of the inductor L1 is connected to a first terminal of the capacitor C2 and the output voltage terminal Vout+. The second terminal of the capacitor C2 is connected to the tap of the secondary winding and to the output voltage terminal Vout−.

The power switches of the IC U1 are driven in a complementary manner. If the IC U1 includes first and second power switches in a half-bridge arrangement, then, when the first power switch is on, the second power switch is off and, when the first power switch is off, the second power switch is on. If the IC U1 includes first, second, third, and fourth power switches in a full-bridge arrangement, then, when the first and the third power switches are on, the second and the fourth power switches are off, and, when the first and the third power switches are off, the second and the fourth power switches are on. In both the half-bridge and full-bridge arrangements, it is possible to include a dead time when all of the power switches are off. The duty cycle of the power switches can be set according to the following equation (1):

$$Duty Cycle = \frac{S 1 turns}{S 1 turns + S 2 turns} \qquad ( 1 )$$

The IC U1 can set the duty cycle of the power switches based on the feedback signal of the feedback terminal FB, which is connected to the switch-output terminal SW via the voltage divider. That is, the voltage divider can be chosen so that the feedback signal received by the feedback terminal FB sets the duty cycle of the power switches in the IC U1 according to equation (1).

The efficiency of the converter can be improved because the peak current of the converter is reduced. When there is no voltage difference of the applied voltage on the inductor L1 during on and off period, the appeared triangle current peak can be zero. The efficiency can be improved because the loss due to the peak current is zero. Load regulation can be improved because the appeared voltage from the diodes D1, D2 are even.

As an example configuration, if the number of turns in the first secondary windings S1 is nine and if the number of turns in the second secondary windings S2 is ten, then the IC U1 can set the duty cycle of the power switches to 47.4%=(9 (S1 Turns)/(9 (S1 Turns)+10 (S2 turns))). Because the duty cycle is adjusted by the voltage divider, which includes the resistors R23 and R18, it can be easily adjusted by changing values of components in accordance with the winding turns in the first secondary winding S1 and the second secondary winding S2.

Example embodiments of the present invention can be used with any boost converter technology, including, for example, an LED boost converter and wireless charging technology.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A DC-DC converter comprising:
input voltage terminals and output voltage terminals;
a transformer including a primary winding, a first secondary winding, and a second secondary winding, the first and the second secondary windings having a different number of turns;
a primary circuit connected between the input voltage terminals and the primary winding and including:
an integrated circuit (IC) including power switches, a switch-output terminal, and a feedback terminal; and
a voltage divider connected between the switch-output terminal and the feedback terminal such that a duty cycle of the power switches is set by equation (1):
$$Duty Cycle = \frac{S 1 turns}{S 1 turns + S 2 turns} \qquad ( 1 )$$
where S1 turns is a number of turns in the first secondary winding and S2 turns is a number of turns in the second secondary winding; and
a secondary circuit connected to the first and the second secondary windings and including a rectifier and the output voltage terminals.

2. The DC-DC converter of claim 1, wherein the power switches are arranged in a half-bridge arrangement.

3. The DC-DC converter of claim 1, wherein the power switches are arranged in a full-bridge arrangement.

4. The DC-DC converter of claim 1, wherein
the voltage divider includes first and second resistors connected in series between the switch-output terminal and a ground; and
the feedback terminal is connected to a node between the first and the second resistors.

5. The DC-DC converter of claim 4, further comprising a third resistor connected between the feedback terminal and the node between the first and the second resistors.

6. The DC-DC converter of claim 1, wherein the first and the second secondary windings define a tap that is connected to one of the output voltage terminals.

7. The DC-DC converter of claim 1, wherein the rectifier includes a first diode connected to the first secondary winding and includes a second diode connected to the second secondary winding.

8. The DC-DC converter of claim 1, wherein the secondary circuit includes a filter connected between the rectifier and the output terminals.

9. The DC-DC converter of claim 8, wherein the filter includes a filter capacitor connected across the output voltage terminals and includes a filter inductor connected between the rectifier and the filter capacitor.

10. The DC-DC converter of claim 1, wherein the IC includes a bootstrap terminal connected to the switch-output terminal.

11. The DC-DC converter of claim 10, further comprising a bootstrap capacitor and a bootstrap resistor connected in series between the bootstrap terminal and the switch-output terminal.

12. The DC-DC converter of claim 1, further comprising a capacitor connected between the primary winding and one of the input voltage terminals.

13. The DC-DC converter of claim 1, further comprising an input capacitor connected between the input voltage terminals.
